(19) United States
(12) Patent Application Publication
(10) Pub. No.: US 2013/0063096 A1
(43) Pub. Date: Mar. 14, 2013

(54) METHOD FOR CONTROLLING THE MAXIMUM CHARGE RATE OF AN ELECTROCHEMICAL ENERGY STORAGE DEVICE

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/698,464

(22) PCT Filed: May 12, 2011
(86) PCT No.: PCT/EP11/02360

§ 371 Date: Nov. 16, 2012

(30) Foreign Application Priority Data
May 19, 2010 (DE) 10-2010-020-993.7

(51) Int. Cl. H02J 7/00

(52) U.S. Cl. 320/134

(57) ABSTRACT

A method for controlling the maximum charge rate during a charging process or discharging process of an electrochemical energy store device is generally characterised by current intensity. Said current intensity is dependent on the operating state of the electrochemical energy store device and on a group of boundary conditions. Said group typically comprises, for example, the temperature of at least one region of the electrochemical energy store device. The maximum charge rate may crucially depend on the mode of operation of the electrochemical energy store device, and therefore a distinction should be made in particular as to whether energy is being supplied to or withdrawn from said device. The electrochemical energy store device can heat up during charging or discharging processes, and therefore in particular the duration of the energy withdrawal and/or energy supply can influence the level of the current intensity which can be withdrawn and/or which can be supplied. The current intensity which can be withdrawn and/or supplied depends in particular upon the state of charge of the electrochemical energy store unit and is therefore controlled in particular on the basis of said state of charge. When in a critical temperature range, the electrochemical energy store cell is particularly difficult to control. Therefore, the current intensity which can be withdrawn or supplied is set to zero when a maximum temperature is reached and/or a minimum temperature is reached.

The present invention relates to a method for controlling the maximum charge rate of an electrochemical energy storage device and an electrochemical energy storage device using such a method.

Electrochemical energy storage devices are generally costly components. In order to manufacture products as economically and thus competitively as possible, it is necessary to operate and utilize all components, and particularly the electrochemical energy storage devices, to their performance limits. Operating electrochemical energy storage devices at less than maximum possible performance limits results in an expensive and inefficient overall system.

However, electrochemical energy storage devices are also highly complex technical devices which can suffer immediate damage if misused. The operating parameters of an electrochemical energy storage device depend on many different boundary conditions such that they are preferably operated efficiently by means of a controller. The maximum charge rate which can be taken from or supplied respectively to an electrochemical energy storage device, particularly an energy storage device comprising at least one lithium ion cell, is a characteristic of the operational strategy on which an electrochemical energy storage device is based. The charge rate of an electrochemical energy storage device can preferably be characterized by the intensity of the current.

The invention will be explained in the following by means of a method for an electrochemical energy storage device, wherein the device is comprised of a plurality of energy storage cells, particularly lithium ion cells. It is pointed out that the method according to the invention can also be advantageously applied to other electrochemical energy storage devices and the description does not limit the applicability of the invention.

Methods for determining and controlling the maximum charge rate for an electrochemical energy storage device are known from the prior art. DE 195 43 874 A1 proposes a simple method for determining the discharge characteristics. The discharge rate is thereby approximated on the basis of the temperature, voltage and current measured at a spatially curved surface. Especially high or low temperatures can in particular result in uncontrolled conditions with respect to the control of the electrochemical energy storage device.

The present invention is based on the object of increasing the usability of an electrochemical energy storage device and in particular improving its operational safety. This object is accomplished in accordance with the invention by the teaching of the independent claims. Preferred further developments of the invention are the subject mater of the dependent subclaims.

A method for controlling the maximum charge rate during charging or discharging of an electrochemical energy storage device can generally be characterized by current intensity. Said current intensity depends on the operating state of the electrochemical energy storage device and on a group of boundary conditions. Said group routinely comprises the temperature of at least one region of the electrochemical energy storage device in particular. As the maximum charge rate can decisively depend on an electrochemical energy storage device's operating mode, a distinction should therefore particularly be made as to whether energy is being supplied to or withdrawn from the electrochemical energy storage device. As the electrochemical energy storage device can heat up during charging or discharging, particularly the duration of the energy withdrawal or supply can thus influence the level of the current intensity able to be withdrawn or supplied. The current intensity which can be withdrawn or supplied depends in particular on the state of charge of the electrochemical energy storage device and is therefore in particular controlled as a function of same. An electrochemical energy storage cell is particularly difficult to control when it is operated in a critical temperature range.

Therefore, the method according to the invention sets the current intensity able to be withdrawn or supplied to zero upon a maximum or a minimum temperature being reached. The maximum charge rate of an electrochemical energy storage device refers to a value which can preferably be characterized by the intensity of a current. The maximum charge rate is preferably thereby characterized by the maximum current intensity which can be supplied to or withdrawn from same under the momentary boundary conditions, such as particularly the temperature of the electrochemical energy storage device, without any damage occurring. Within the scope of the present invention, the maximum charge rate thereby characterizes both the charge rate during charging as well as also the discharge rate during discharging of an electrochemical energy storage device.

Charging particularly refers to supplying electrical energy to the electrochemical energy storage device, whereby preferably at least part of the electrical energy supplied to the electrochemical energy storage device is converted to chemically bound energy and thus stored.

Discharging particularly refers to withdrawing electrical energy from the electrochemical energy storage device. In the process, preferably at least part of the energy stored in chemically bound form in the electrochemical energy storage device is converted into electrical energy.

To be understood by an electrochemical energy storage device is preferably a device for storing electrical energy. The energy is preferably stored in an electrochemical energy storage device in chemically bound form. Said electrochemical energy storage device preferably comprises at least one, and preferentially a plurality of lithium ion cell(s).

The maximum charge rate of an electrochemical energy storage device in particular depends on various different boundary conditions and operating parameters. The temperature of the electrochemical energy storage device is preferably one such boundary condition. The temperature of the electrochemical energy storage device preferably refers to the temperature of at least one region of at least one electrochemical energy storage cell. Said temperature can in particular be directly measured on or in said energy storage cell or the temperature of the energy storage cell can preferably be measured indirectly at one or more sections of the electrochemical energy storage device's housing. Said temperature is preferably used in controlling the maximum charge rate of the electrochemical energy storage device.

Identifying a charging or discharging operation particularly refers to identifying whether energy is being supplied to or withdrawn from the electrochemical energy storage device, preferably by evaluating measured signals in a control unit. The charging or discharging operation is preferably identified by means of a current flow or preferentially by means of a voltage difference.

The duration of a charging or discharging operation particularly refers to the period of time during which a preferably continuous charging or discharging of an electrochemical energy storage device occurs. Preferably also measured is the period of time without any charging or discharging occurring. The duration of the charging/discharging operation is preferably used in the control of the electrochemical energy storage device.

The charge state of the electrochemical energy storage device particularly refers to the relationship between the maximum amount of energy able to be stored in same and the current amount of energy stored in same. The maximum amount of energy able to be stored in the electrochemical energy storage device preferably depends on the aging state of same. The charge state of the electrochemical energy storage device is particularly referred to as the “state of charge” (SOC). The charge state is preferably expressed as a ratio between 0 and 1, whereby 1 in particular means that the electrochemical energy storage device is fully charged.

A maximum temperature is to be understood as a predefined temperature limit. The maximum charge rate is set to a predefined limit value particularly upon said temperature limit being reached or exceeded. The predefined limit value for the maximum charge rate upon the maximum temperature being reached is preferably zero. Preferably, no energy is supplied to or withdrawn from the electrochemical energy storage device upon the maximum temperature being reached.

A minimum temperature is to be understood as a predefined temperature limit. The maximum charge rate is set to a predefined limit value particularly upon the reaching of or falling short of said temperature limit. The predefined limit value for the charge rate upon the minimum temperature being reached is preferably zero. Preferably, no energy is supplied to or withdrawn from the electrochemical energy storage device upon the minimum temperature being reached.

In one preferred embodiment, the charge rate is provided at an interface of the electrochemical energy storage device. Said interface preferably serves to transmit a signal to or from the electrochemical energy storage device. Preferably, a parameter representative of the charge rate is furnished at said interface. The interface can preferably be connected to a bus system. Preferably the charge rate is periodically transmitted to the interface at a predetermined frequency, preferentially from 1 Hz to 50 Hz; 5 Hz-30 Hz is particularly preferential. The frequency of the transmission preferably depends on various different boundary conditions and is variable. The recurring charge rate transmission particularly ensures that current data is always available for controlling the electrochemical energy storage device, thereby in particular improving the operational safety.

In one preferred embodiment, the maximum charge rate parameter depends on how long energy is withdrawn from or supplied to the electrochemical energy storage device. The maximum charge rate is preferably greater the shorter the duration of energy withdrawal or supply is. Preferably, a maximum charge rate is predefined for extremely short energy withdrawal or supply durations. Preferably, a maximum charge rate is defined for extremely long durations of energy being withdrawn from or supplied to the electrochemical energy storage device. These predefined maximum charge rates for the extreme cases particularly ensures that the electrochemical energy storage device will not be overcharged by charge rates which are too high even in the event of extremely short or long discharging or charging operations. Predefined maximum charge rates thus increase the electrochemical energy storage device's operational safety.

In one preferred embodiment, the maximum charge rate can be at least partly specified by an exponentially flattening time function. This time function has its highest value for pulse-like withdrawals or supplies of energy. The exponentially flattening time function shows its lowest value for continuous withdrawal or supplying of energy.

A pulse-like withdrawal or supply of energy thus preferably refers to a tapping or supply of energy of short duration, preferably a duration of less than one second.

A continuous withdrawal or supply of energy thus preferably refers to a tapping or supply of energy of long duration, preferably a duration of more than 60 seconds and particularly preferred of more than 100 seconds.

In one preferred embodiment, the maximum charge rate C is a function of the duration of discharging/charging and conforms to the relationship:

C=(f·C₀·K₁−C₁)·exp(−K_{II}·t)+f·C₁ Eq. 1

wherein
C: maximum charge rate depending on the length of time
C₀: upper control value for the maximum charge rate
C₁: lower control value for the maximum charge rate
f: function for the dependence of charge rate on charge state
t: duration of pulse-like energy withdrawal or energy supply
K_{I}, K_{II}: constants

In one preferred embodiment, the value for the f function is set at a predefined value, said value preferably lying between 0 and 2, preferentially between 0 and 1, and at a particularly preferential value of 1.

To be understood by the upper control value for the maximum charge rate is a parameter which preferably serves to adapt the control of the maximum charge rate to an electrochemical energy storage device.

To be understood by the lower control value for the maximum charge rate is a parameter which preferably serves to adapt the control of the maximum charge rate to an electrochemical energy storage device.

The upper control value of the maximum charge rate is preferably greater than the lower control value. The upper control value is preferentially to be understood as an upper limit value which the maximum charge rate does not exceed. The lower control value is preferably to be regarded as a lower limit value for the maximum charge rate, whereby the maximum charge rate preferably only falls below this lower limit value when set at zero.

An upper and a lower control value particularly achieves a simple adapting of the method for controlling the maximum charge rate to different electrochemical energy storage devices and thus preferably enables high usability for same.

The progression of the maximum charge rate is preferably parameterized over the duration of the pulse-like energy withdrawal or supply by the two K_{I} and K_{II} constants. The K_{I} constant is preferably in a range of from 0.5 to 2, preferentially from 0.85 to 1.25, and particularly preferential at approximately 1.05. The K_{II} constant is preferably in a range of from 0.001 to 0.5, preferentially from 0.03 to 0.09, and particularly preferential at approximately 0.055.

In one preferred embodiment, the value of the f function depends on the SOC, thus preferably each and particularly preferably some of the different charge states of the electrochemical energy storage device is assigned a different maximum charge rate. Preferably, the f function is a cubic or linear function, preferentially quadratic. The f function preferably exhibits the form shown in Eq. 2:

f=−K_{III}·SOC²+K_{IV}·SOC−K_{V} Eq. 2

wherein
SOC: state of charge of the electrochemical energy storage device
K_{III}, K_{IV}, K_{V}: constants

The K_{III}, K_{IV} and K_{V} constants are preferably selected so as to result in a monotonically decreasing f function, the f function preferably decreases monotonically at least within one range of SOC values. Preferably, for f less than zero, f=0, and for f greater than 1, f=1.

The K_{III} constant is preferably in a range of from 0.001 to 0.5, preferentially 0.005 to 0.07, and particularly preferably at approximately 0.012. The K_{IV} constant is preferably in a range of from 0.01 to 10, preferentially 1.5 to 3, and particularly preferential at approximately 2.182. The K_{V} constant is preferably in a range of from 50 to 100, preferentially 75 to 99.5, and particularly preferential at approximately 98.19.

In one preferred embodiment, the maximum charge rate for the supplying of energy and the withdrawing of energy is determined by means of different f functions. Preferably, the maximum charge rate during energy withdrawal is not a function of the electrochemical energy storage device's state of charge. The f function value for the energy supply or the energy withdrawal is preferably determined at least with different K_{I} to K_{V} constants, whereby the individual K_{I} to K_{V} constants are preferably the same for the energy withdrawal and the energy supply.

Parameterizing the maximum charge rate by means of the K_{I} to K_{V} constants achieves good adaptability of the control method to different electrochemical energy storage devices and thus a high usability for same.

By specifying the charge rate as a function of the duration of energy supply to or energy withdrawal from the electrochemical energy storage device particularly achieves that same will not be overcharged, thus increasing the operational safety of an electrochemical energy storage device through the control according to an inventive method.

In one preferred embodiment, the charge rate is in particular lower the lower the temperature of the electrochemical energy storage device is during energy withdrawal or supply. The charge rate is in particular higher the higher the temperature of the electrochemical energy storage device is during energy withdrawal or supply. These correlations particularly apply only in an operational range for the electrochemical energy storage device limited by maximum/minimum temperatures. In particular, preferably no supplying to or withdrawing of energy from the electrochemical energy storage device is possible above the maximum temperature or below the minimum temperature. What the limiting of an operational range by a minimum/maximum temperature and by the temperature-dependent charge rate within the given operational range particularly achieves is that the electrochemical energy storage device will not be overcharged, thus a method for controlling the maximum charge rate increases the operational safety of an electrochemical energy storage device.

Preferably, the maximum charge rate is regulated to a predefined limit value as of a minimum temperature from −40° C. to −25° C. Said predefined charge rate limit value is preferably zero. Said predefined limit value particularly achieves that no energy can be supplied to or withdrawn from the electrochemical energy storage device once said minimum temperature is reached. Preferably, the maximum electrochemical energy storage device charge rate is regulated to a predefined limit value as of a maximum temperature of from 55° C. to 80° C. Said predefined charge rate limit value is preferably zero. Said predefined limit value particularly achieves that no energy can be supplied to or withdrawn from the electrochemical energy storage device once said maximum temperature is reached. The predefined minimum/maximum temperature particularly prevents uncontrolled reactions from occurring in the electrochemical energy storage device above or below these temperatures. Thus, controlling the maximum charge rate by means of a minimum/maximum temperature increases the operational safety of the electrochemical energy storage device.

In one preferred embodiment, the charge rate during charging differs, at least to some extent, from the charge rate during discharging.

In one preferred embodiment, the electrochemical energy storage device comprises a controller which in particular controls the maximum charge rate according to the inventive method. Controlling the maximum charge rate according to the inventive method increases the operational safety of the electrochemical energy storage device.

Further advantages and embodiments of the present invention are indicated in the accompanying drawings.

Shown are:

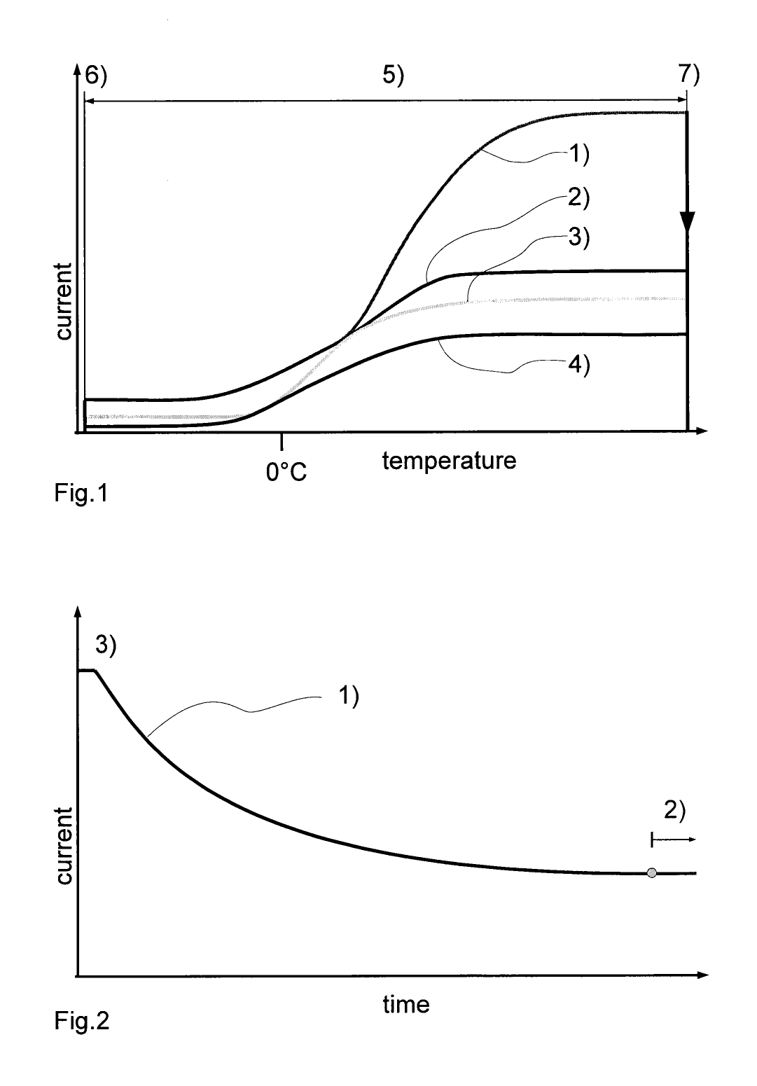

FIG. 1: the relationship between current intensity and temperature for different charging durations,

FIG. 2: the relationship between current intensity and charging duration,

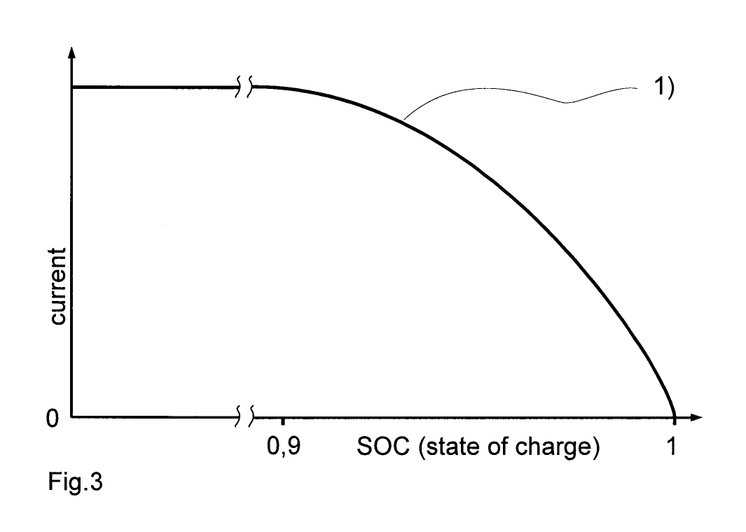

FIG. 3: the relationship between the state of charge of the electrochemical energy storage device and the charging current intensity.

FIG. 1 shows the basic relationship between current intensity during charging/discharging and temperature. The current intensity thereby characterizes the maximum charge rate. It can hereby be recognized that as the temperature drops, the current intensity able to be withdrawn from or stored in the electrochemical energy storage device decreases.

FIG. 1 depicts different current curves 1)-4) for different tapping/storing durations. The current curve identified as 1) thereby shows the characteristic current draw for a very short discharge pulse. A short discharge pulse is thereby particularly to be understood as a discharge lasting 1 second or less. As the duration of the electrochemical energy storage device's discharge increases, the current intensity able to be tapped, and thus the maximum charge rate, drops. This is shown by the current curve identified as 2) as this is a current curve for a discharge lasting about 10 seconds. If the duration of the discharge now continues to increase, the current intensity able to be tapped also drops further. This is shown by the current curves identified as 3) and 4). Current curve 3) represents the current intensity for a discharge lasting about 30 seconds and current curve 4) represents the current intensity able to be continuously tapped from the electrochemical energy storage device.

It can be noted from FIG. 1 that the electrochemical energy storage device is operated within the temperature range identified as 5). The temperature range identified as 5) is limited by a minimum limiting temperature, identified as 6), as well as a maximum limiting temperature, identified as 7). Upon one of these two limiting temperatures being reached, the current intensity able to be tapped from the electrochemical energy storage device is set to zero. This controlling of the maximum charge rate back to zero upon a limiting temperature being reached particularly achieves safe operation of the electrochemical energy storage device.

FIG. 2 depicts the relationship between the current intensity characterizing the charge rate and the duration of discharging.

FIG. 2 thereby shows that the current intensity able to be withdrawn and thus the maximum charge rate decreases with increasing duration of discharge. In the case of very short periods, the withdrawable current intensity is limited to a maximum value identified as 3). Although this current intensity limiting is not necessary, it does result in improving the operational safety. The limiting to a maximum current intensity value thus increases the electrochemical energy storage device's operational safety. In the case of very long withdrawal periods, the current intensity able to be drawn from the electrochemical energy storage device is set to the limiting value identified as 2). This defining of a minimum withdrawable current intensity increases the usability of the electrochemical energy storage device.

FIG. 3 shows the relationship between the current intensity characterizing the charge rate and the electrochemical energy storage device's charge state. The electrochemical energy storage device's charge state is often called the “state of charge” (SOC). When the electrochemical energy storage device is fully charged, the SOC amounts to 1, respectively 100%.

When the SOC reaches a predefined threshold, the current intensity will then decrease by the current curve identified as 1) when the electrochemical energy storage device is being charged. Each different SOC can also be assigned its own maximum charge rate and thus current intensity. The tappable current intensity can be a function of the electrochemical energy storage device's SOC even during discharging. Once the electrochemical energy storage device reaches full charge (SOC=1), the charging current intensity is set to zero. Regulating the current intensity during charging/discharging as a function of the SOC in particular increases the operational safety of the electrochemical energy storage device and its usability.

1-9. (canceled)

10. A method for controlling a maximum charge rate during charging or discharging of an electrochemical energy storage device, the maximum charge rate being characterized by at least one current intensity, the method comprising:
determining the at least one current intensity based on at least one predetermined relationship to another parameter, the other parameter including:
a temperature of at least one region of the electrochemical energy storage device,
an identification of whether charging or discharging is occurring,
a duration of the charging or discharging, and
a state of charge of the electrochemical energy storage device,
wherein the current intensity is set to zero upon reaching a maximum or a minimum temperature, and the maximum charge rate increases as a duration of energy withdrawal or supply decreases.

11. The method for controlling a maximum charge rate during charging or discharging of an electrochemical energy storage device according to claim 10, wherein the maximum charge rate decreases as the temperature of the at least one region of the electrochemical energy storage device decreases during energy withdrawal or supply.

12. The method for controlling a maximum charge rate during charging or discharging of an electrochemical energy storage device according to claim 10, wherein the maximum charge rate, or a corresponding parameter, is transmitted from the electrochemical energy storage device to an interface.

13. The method for controlling a maximum charge rate during charging or discharging of an electrochemical energy storage device according to claim 10, wherein the maximum charge rate increases as a duration of energy withdrawal or supply increases.

14. The method for controlling a maximum charge rate during charging or discharging of an electrochemical energy storage device according to claim 10, wherein the maximum charge rate is specified by an exponentially flattening time function which has a highest value for a pulsed withdrawal or supply of energy and has a lowest value for a continuous withdrawal or supply of energy.

15. The method for controlling the maximum charge rate during charging or discharging of an electrochemical energy storage device according to claim 10, wherein the maximum charge rate is set to zero for temperature values at or below a lower limit temperature in a range of −25° to −40° Celsius and for temperature values at or above an upper limit temperature in a range of 55° to 80° Celsius.

16. The method for controlling the maximum charge rate during charging or discharging of an electrochemical energy storage device according to claim 10, wherein the maximum charge rate is controlled in relation to a time period t that specifies a duration of energy supply to or energy withdrawal from the electrochemical energy storage device, wherein the maximum charge rate C conforms to a function:
C=(f·C₀·K_{I}−C₁)·exp(−K_{II}·t)+f·C₁
wherein
C0 is an upper control value for the maximum charge rate,
C1 is a lower control value for the maximum charge rate,
f specifies a dependency of the maximum charge rate on the state of charge of the electrochemical energy storage device, and
KI, KII are constants for parameterizing control of the maximum charge rate.

17. The method for controlling the maximum charge rate during charging or discharging of an electrochemical energy storage device according to claim 16, wherein the dependency of the maximum charge rate f on a current state of charge conforms to a function:
f=−K_{III}·SOC²+K_{IV}·SOC−K_{V}
wherein
SOC expresses the state of charge of the electrochemical energy storage device, and
KIII, KIV, KV are constants for parameterizing the control of the maximum charge rate.

18. An electrochemical energy storage device, wherein a maximum charge rate during charging or discharging thereof is controlled in accordance with a method according to claim 10.

19. The method for controlling a maximum charge rate during charging or discharging of an electrochemical energy storage device according to claim 12, wherein the interface is a bus system.

20. The method for controlling a maximum charge rate during charging or discharging of an electrochemical energy storage device according to claim 13, wherein a maximum charge rate is defined for energy withdrawal or supply durations shorter than a predetermined time period.

21. The method for controlling a maximum charge rate during charging or discharging of an electrochemical energy storage device according to claim 20, wherein a maximum charge rate is defined for energy withdrawal or supply durations longer than a second predetermined time period.
